(19) United States
(12) Patent Application Publication
(10) Pub. No.: US 2008/0174520 A1
(43) Pub. Date: Jul. 24, 2008

(54) APPARATUS AND DRIVING METHOD OF PLASMA DISPLAY

(76) Inventors: Suk-Ki Kim, Yongin-si (KR); Jeong-Hoon Kim, Yongin-si (KR); Jung-Pil Park, Yongin-si (KR); Sang-Min Nam, Yongin-si (KR)

Correspondence Address: CHRISTIE, PARKER & HALE, LLP, PO BOX 7068, PASADENA, CA, 91109-7068, US

(21) Appl. No.: 11/744,201

(22) Filed: May 3, 2007

(30) Foreign Application Priority Data
Jan. 19, 2007 (KR) 10-2007-0005865

(51) Int. Cl. G09G 3/28

(52) U.S. Cl. 345/60

(57) ABSTRACT

A plasma display device and a driving method thereof. The plasma display device includes drivers for scan, sustain and address electrodes and a controller for controlling the drivers. The scan electrode driver includes a capacitor whose charge is proportional to an on period of a switch included in the driver circuit or may be otherwise controlled. By controlling the charge of the capacitor, a voltage difference between the reset falling voltage and the select voltage that are applied to the scan electrodes during the reset and subsequent address periods can be controlled to control the discharge margin and to correspond to the design of the plasma display device. The need for a Zener diode with a high withstand voltage is alleviated.

### CROSS-REFERENCE TO RELATED APPLICATION

This application claims priority to and the benefit of Korean Patent Application No. 10-2007-0005865 filed in the Korean Intellectual Property Office on Jan. 19, 2007, the entire content of which is incorporated herein by reference.

### BACKGROUND OF THE INVENTION

1. Field of the Invention

The present invention relates to a plasma display device and a driving method thereof and, more particularly, to a driver circuit for a plasma display device that permits varying a difference between a reset voltage and a select voltage and a method for operating the driver circuit.

2. Description of the Related Art

A plasma display device is a flat panel display that uses plasma generated by a gas discharge to display characters or images. It includes a plasma display panel (PDP) wherein a number of discharge cells (hereinafter, referred to as cells) are arranged in a matrix format, depending on the size of the panel.

According to a typical driving method of a PDP, each frame is divided into a plurality of subfields each having a corresponding weight, and grayscales are expressed by a combination of weights of the subfields that are used to perform a display operation. Each subfield is divided into a reset period, an address period, and a sustain period. A wall charge state of a discharge cell is initialized during the reset period, turn-on cells are selected during the address period, and a sustain discharge operation is performed in the turn-on cells for displaying an image during the sustain period. Turn-on cells, or on cells, are cells that are turned on during the sustain period.

A conventional plasma display device applies a scan voltage to a scan electrode for selecting a turn-on cell during an address period, and a voltage that is higher than the scan voltage is typically applied to the scan electrode at the end of a reset period that precedes the address period. A driving circuit used for application of these voltages will be described with reference to FIG. 1.

FIG. 1 shows a part of a conventional driving apparatus of a plasma display device that drives a scan electrode.

As shown in FIG. 1, a conventional driving apparatus 10 includes a transistor YscL, a Zener diode ZD1, and a transistor Yfr. A drain of the transistor YscL is coupled to a scan electrode Y and a source of the transistor YscL is coupled to a power source VscL. A cathode of the Zener diode ZD1 is coupled to the scan electrode Y and an anode of the Zener diode ZD1 is coupled to a drain of the transistor Yfr. A source of the transistor Yfr is coupled to the power source VscL. The scan electrode Y and a corresponding sustain electrode X, together form a panel capacitor Cp.

At the end of the reset period, the transistor Yf is turned on and the transistor YscL is turned off. Accordingly, a current path is formed from the scan electrode Y through the Zener diode ZD1 and the transistor Yfr to the power source VscL, and a voltage applied to the scan electrode Y is maintained higher than a voltage of VscL at the power source VscL by a constant level ΔV due to the Zener diode ZD1.

In an address period, the transistor Yfr is turned off and the transistor YscL is turned on. Accordingly, a current path is formed from the scan electrode Y through the transistor YscL to the power source VscL, and a voltage applied to the scan electrode corresponds to the voltage VscL. The voltage VscL is a scan select voltage for selecting the scan electrodes.

Typically, the voltage VscL is set to about −200 V, and the constant level ΔV is set to about 25 V. Therefore, the Zener diode ZD1 has a high withstand voltage of about 175V. However, the use of a Zener diode having such a high withstand voltage has drawbacks of increasing implementation costs as well as power consumption.

In addition, the conventional driving apparatus 10 of FIG. 1 cannot modify the size of ΔV so that it cannot correspond to the design of a plasma display device and cannot be varied according to a discharge margin.

### SUMMARY OF THE INVENTION

An exemplary plasma display device according to one embodiment of the present invention includes a PDP, a power supply, and a controller. The PDP includes a plurality of first electrodes, a plurality of second electrodes, and a plurality of third electrodes crossing a direction of the first and second electrodes. The power supply generates a first voltage by converting an input voltage. The power supply includes a first power supply for supplying the first voltage. The first driving circuit drives each of the first electrodes. The controller generates a control signal so as to control a driving operation of the first driving circuit. The first driving circuit includes a first switch, a second switch, a third switch, and a first capacitor. The first switch has a first end coupled to the first power source that supplies the first voltage. The second switch has a first end coupled to a second end of the first switch and a second end coupled to the first electrode. The third switch has a first end coupled to the first electrode and a second end coupled to a second power source that supplies a second voltage. The first capacitor has a first end coupled to a node formed between the first switch and the second switch and a second end coupled to the second end of the third switch.

An exemplary plasma display device according to one embodiment of the present invention includes a PDP, a power supply, a first driving circuit, and a controller. The PDP has a plurality of first electrodes, a plurality of second electrodes, and a plurality of third electrodes crossing over the first and second electrodes. The power supply generates a first voltage by converting an input voltage. The power supply includes a first power source that supplies the first voltage. The first driving circuit drives the first electrodes. The controller generates a control signal so as to control a driving operation of the first driving circuit. The first driving circuit includes a first switch, a second switch, a first capacitor, a first diode, and a first transformer. The first switch has a first end coupled to the first power source that supplies the first voltage and a second end coupled to the first electrode. The second switch has a first end coupled to the first electrode. The first capacitor has a first end coupled to the first end of the first switch and a second end coupled to the second switch. The first diode has an anode coupled to the second end of the first capacitor. The first transformer has a primary coil and a secondary coil. A first end of the secondary coil is coupled to the first end of the first capacitor. A second end of the secondary coil is coupled to the second end of the first capacitor. The secondary coil charges the first capacitor with a third voltage that is generated in proportion to a second voltage that is applied to the primary coil.

An exemplary driving method according to one embodiment of the present invention drives a plasma display device having a plurality of first electrodes, a plurality of second electrodes, and a plurality of third electrodes crossing over the first and second electrodes. The plasma display device includes a first switch, a second switch, a third switch, and a first capacitor. The first switch has a first end coupled to a first power source that supplies a first voltage. The second switch has a first end coupled to a second end of the first switch and a second end coupled to the first electrode. The third switch has a first end coupled to the first electrode and a second end coupled to a second power source that supplies a second voltage. The first capacitor has a first end coupled to a node between the first switch and the second switch and a second end coupled to the second end of the third switch.

The driving method according to the embodiments of the invention includes charging the first capacitor with the third voltage by turning on the second switch and turning off the first and third switches, applying the first voltage to the first electrode by turning on the first and second switches and turning off the third switch, and applying a fourth voltage to the first electrode by turning on the first and third switches and turning off the second switch. The fourth voltage is lower than the first voltage by the amount or magnitude of the third voltage.

### BRIEF DESCRIPTION OF THE DRAWINGS

FIG. 1 shows a conventional driving apparatus that drives a scan electrode of a plasma display device.

FIG. 2 is a block diagram of a plasma display device according to an exemplary embodiment of the present invention.

FIG. 3 shows a scan electrode driver according to a first exemplary embodiment of the present invention.

FIG. 4 shows a driving waveform diagram of the plasma display device according to the first exemplary embodiment of the present invention.

FIG. 5A shows a first current path and a second current path, each formed for charging a capacitor C1 of the scan electrode driver 400 according to the first exemplary embodiment of the present invention.

FIG. 5B shows a current path for supplying a voltage Vnf and a voltage VscL to a scan electrode Y by using the scan electrode driver 400 according to the first exemplary embodiment of the present invention.

FIG. 6 shows a scan electrode driver according to a second exemplary embodiment of the present invention.

FIG. 7 shows a scan electrode driver according to a third exemplary embodiment of the present invention.

### DETAILED DESCRIPTION OF THE EMBODIMENTS

Throughout this specification and the claims that follow, when it is described that an element is “coupled” to another element, the element may be “directly coupled” to the other element or “electrically coupled” to the other element through a third element.

Wall charges being described in the present invention are charges formed on a wall (e.g., a dielectric layer) close to each electrode of a discharge cell. The wall charges will be described as being “formed” or “accumulated” on the electrode, although the wall charges do not actually touch the electrodes. Further, a wall voltage is a potential difference between the voltages formed on the walls of the discharge cell by the wall charges.

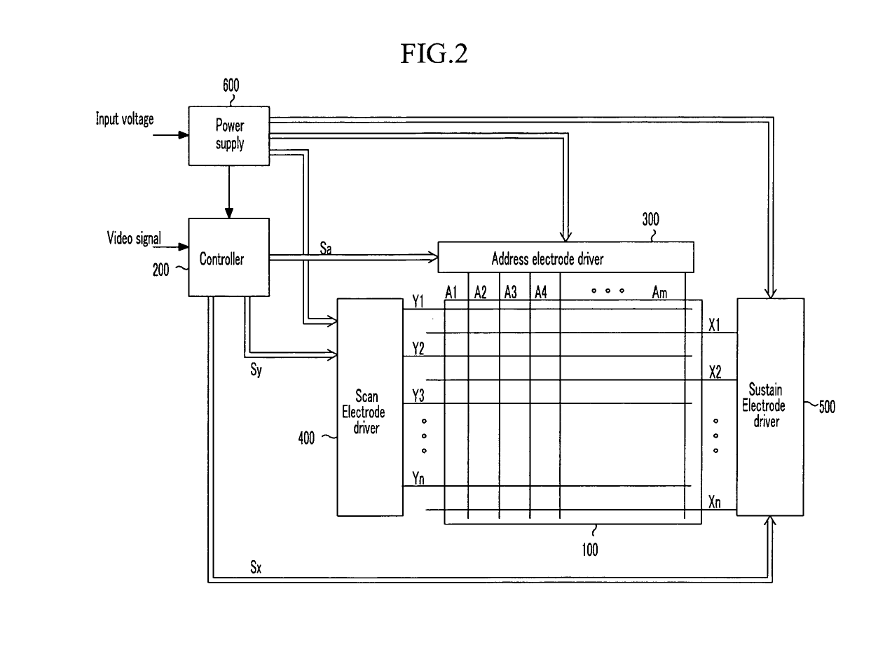

FIG. 2 is a block diagram of a plasma display device according to an exemplary embodiment of the present invention.

The plasma display device of FIG. 2 includes a plasma display panel (PDP) 100, a controller 200, an address electrode driver 300, a scan electrode driver 400, a sustain electrode driver 500, and a power supply 600.

The PDP 100 includes a plurality of address electrodes A1 to Am extending in a column direction, and a plurality of sustain electrodes X1 to Xn and a plurality of scan electrodes Y1 to Yn extending in a row direction. Generally, the sustain electrodes X1 to Xn are formed corresponding to scan electrodes Y1 to Yn. Further, the ends of the common electrodes X1 to Xn are coupled to one another. In addition, the PDP 100 includes a substrate on which the sustain and scan electrodes X1 to Xn and Y1 to Yn are arranged (not shown), and another substrate on which the address electrodes A1 to Am are arranged (not shown). The two substrates are placed facing each other with a discharge space therebetween so that the scan electrodes Y1 to Yn and the address electrodes A1 to Am may perpendicularly cross over each other and the sustain electrodes X1 to Xn and the address electrodes A1 to Am may also perpendicularly cross over each other. Here, the discharge space formed at a crossing region of the address electrodes A1 to Am and the sustain and scan electrodes X1 to Xn, and Y1 to Yn forms a discharge cell. This is an exemplary structure of the PDP 100, and panels of other structures can be applied to the present invention.

The controller 200 receives external video signals and outputs an address electrode driving control signal Sa, a sustain electrode driving control signal Sx, and a scan electrode driving control signal Sy. In addition, the controller 200 divides one frame into a plurality of subfields and drives the subfields. Each subfield includes a reset period, an address period, and a sustain period. Further, the controller 200 generates a scan high voltage Vscn_h by using a direct current (DC) voltage supplied from the power supply 600 and transmits the scan high voltage Vscn_h to the scan electrode driver 400 or the sustain electrode driver 500. The scan or sustain electrode drivers 400, 500 apply a corresponding signal to a cell that has not been addressed during an address period.

The address electrode driver 300 receives the address electrode driving control signal Sa from the controller 200 and applies a display data signal to each address electrode so as to select discharge cells for forming the image being displayed.

The scan electrode driver 400 receives the scan electrode driving control signal Sy from the controller 200 and applies a driving voltage to a scan electrode Y.

The sustain electrode driver 500 receives the sustain electrode driving control signal Sx from the controller 200 and applies a driving voltage to a sustain electrode X.

The power supply 600 supplies power for driving the plasma display device to the controller 200 and the drivers 300, 400, and 500. An input voltage is provided to the power supply 600 and the power supply generates various voltages to be applied to different drivers. For example, the power supply may include a power source that receives the input voltage and generate a voltage to be applied to one or more of the drivers.

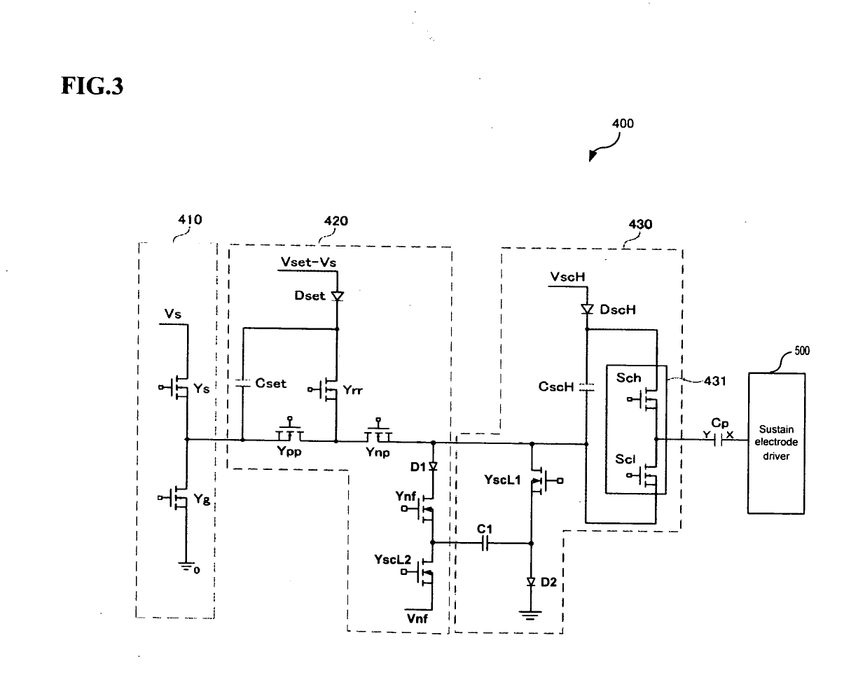

FIG. 3 shows a scan electrode driver 400 according to a first exemplary embodiment of the present invention. The switches used in the circuit of the scan electrode driver 400 are shown and described as n-channel field effect transistors (FET). The n-channel field effect transistor switches also include a body diode that is not shown. These transistor switches, however, can be replaced with another type of switch that has the same or similar functions. A capacitive component formed by a sustain electrode X and a scan electrode Y is described as a panel capacitor Cp.

As shown in FIG. 3, the scan electrode driver 400 according to the first exemplary embodiment of the present invention includes a sustain driver 410, a reset driver 420, and a scan driver 430.

The sustain driver 410 includes a transistor Ys and a transistor Yg. The transistor Ys has a drain coupled to a power source Vs that supplies a voltage Vs and a source coupled to the scan electrode Y of the panel capacitor Cp. The transistor Yg has a drain coupled to the scan electrode Y of the panel capacitor Cp and a source coupled to a power source that supplies 0V or to ground. The transistor Ys applies the voltage Vs to the scan electrode Y, and the transistor Yg applies 0V to the scan electrode Y.

Although it is not shown in FIG. 3, the sustain driver 410 may also include an energy recovery circuit (ERC) that recovers the voltage applied to the panel capacitor Cp.

The reset driver 420 includes transistors Yrr, Ynf, Ypp, Ynp, and YscL2, a capacitor Cset, and diodes Dset and D1. The reset driver 420 gradually increases a voltage of the scan electrode Y from the voltage Vs to a voltage Vset during a rising period of a reset period and gradually decreases the voltage of the scan electrode Y from the voltage Vs to the voltage Vnf during a falling period of the reset period.

A drain of the transistor Yrr is coupled to a power source (Vset−Vs) that supplies a voltage (Vset−Vs) and a source of the transistor Yrr is coupled to the scan electrode Y. A drain of the transistor Ynp is coupled to the source of the transistor Yrr and a source of the transistor Ynp is coupled to the scan electrode Y. In addition, a drain of the transistor Ypp is coupled to the source of the transistor Yrr and a source of the transistor Ypp is coupled to a node formed where the transistor Ys and the transistor Yg are coupled together. A capacitor Cset has one end coupled to the power source (Vset−Vs) and the other end coupled to the source of the transistor Ypp. The capacitor Cset is charged with the voltage (Vset−Vs) when the transistor Yg is turned on. In addition, in order to block current flow due to a body diode of the transistor Yrr, the diode Dset is coupled between the drain of the transistor Yrr and the power source (Vset-Vs) in a direction opposite to the body diode of the transistor Yrr.

The transistor YscL2 and the transistor Ynf are coupled in series between a power source that supplies the voltage Vnf and the scan electrode Y of the panel capacitor Cp. In order to block current flow due to a body diode of the transistor Ynf, the diode D1 is coupled between the transistor Ynf and the scan electrode Y in a direction opposite to the body diode of the transistor Ynf. The transistors YscL2 and Ynf are turned on/off by a control signal input from the controller 200 of FIG. 2 and selectively supply the voltage Vnf to the scan electrode Y. The voltage Vnf and the voltage VscL are generated by the power supply 600 of FIG. 2 and are input to the scan electrode driver 400. The voltage Vnf is higher than the voltage VscL by a level A V. The level ΔV may be constant or predetermined.

The scan driver 430 includes a selection circuit 431, capacitors CscH and C1, diodes DscH and D2, and a transistor YscL1. During the address period, the scan driver 430 applies the voltage VcsL to the scan electrode Y to select a turn-on discharge cell and applies a voltage VscH to scan electrodes Y of unselected discharge cells. In some embodiments, the selection circuit 431 is coupled in the form of an integrated circuit (IC) between a plurality of scan electrodes Y1 to Yn so as to sequentially select the plurality of scan electrodes Y1 to Yn during the address period. A driving circuit of the scan electrode driver 400 can be coupled to the scan electrodes Y1 to Yn through the selection circuit 431. In FIG. 3, one scan electrode Y and a corresponding selection circuit 431 are illustrated.

The selection circuit 431 includes transistors Sch and Scl. A source of the transistor Sch and a drain of the transistor Scl are coupled to the scan electrode Y of the panel capacitor Cp. The capacitor CscH has one end coupled to a node formed between the source of the Scl and a drain of the transistor YscL1. The other end of the capacitor CscH is coupled to a drain of the transistor Sch.

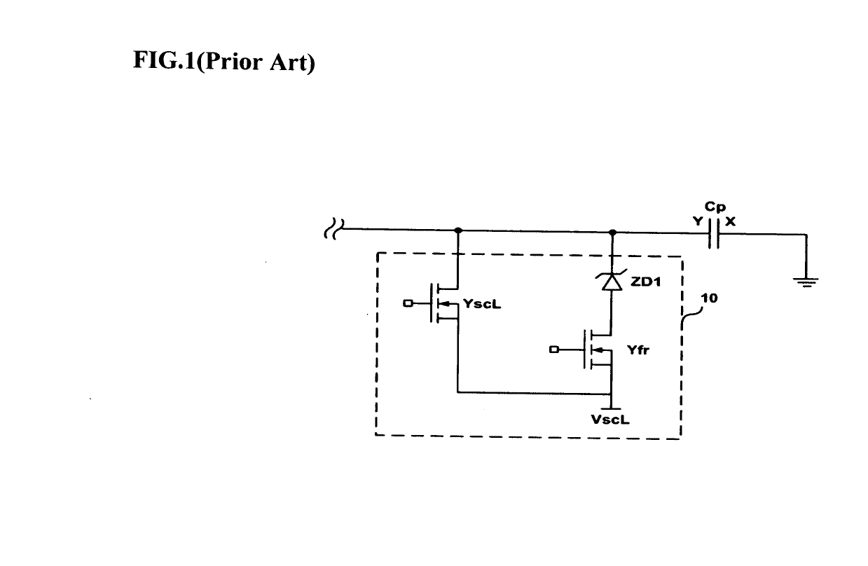

The transistor YscL1 is coupled between ground and the panel capacitor Cp. The capacitor C1 has one end coupled to a source of the transistor YscL1 and the other end coupled to a node formed between the transistor Ynf and the transistor YscL2 of the reset driver 420. The diode D2 has an anode coupled to one end of the capacitor C1 and a cathode coupled to ground. The diode DscH has an anode coupled to a power source VscH that supplies a voltage VscH and a cathode coupled to the drain of the transistor Sch. The capacitor CscH is charged with a voltage (VscH−VscL) when the transistor YscL1 is turned on. The transistor YscL1 is turned on/off by a control signal input from the controller 200 of FIG. 1 and selectively supplies the voltage VscL to the scan electrode Y.

In FIG. 3, the transistors Ys, Yg, Yrr, YscL1, YscL2, Ynf, Sch, Scl, Ynp, and Ypp are each illustrated as one transistor. In one embodiment, each of the transistors Ys, Yg, Yrr, YscL1, YscL2, Ynf, Sch, Scl, Ynp, and Ypp can be implemented as a plurality of transistors coupled in parallel.

The scan electrode driver 400 of FIG. 3 according to the first exemplary embodiment of the present invention, supplies the voltage Vnf to the scan electrode Y by controlling turn-on/turn-off of the power supply Vnf and the transistors Ynf, YscL1, and YscL2 rather than providing the voltage Vnf by using the power source VscL and the Zener diode ZD1 in the conventional method shown in FIG. 1. Thus, implementation costs and driving power consumption of the plasma display device can be reduced, compared to the conventional plasma display device that uses the Zener diode having a high withstand voltage. In addition, the voltage Vnf is separately generated by using the power supply 600 of FIG. 2, and therefore the voltage Vnf can be modified through an external input.

Driving operation of the scan electrode driver 400 according to the first exemplary embodiment of the present invention will be described in further detail with reference to FIGS. 3, 4, 5A and 5B.

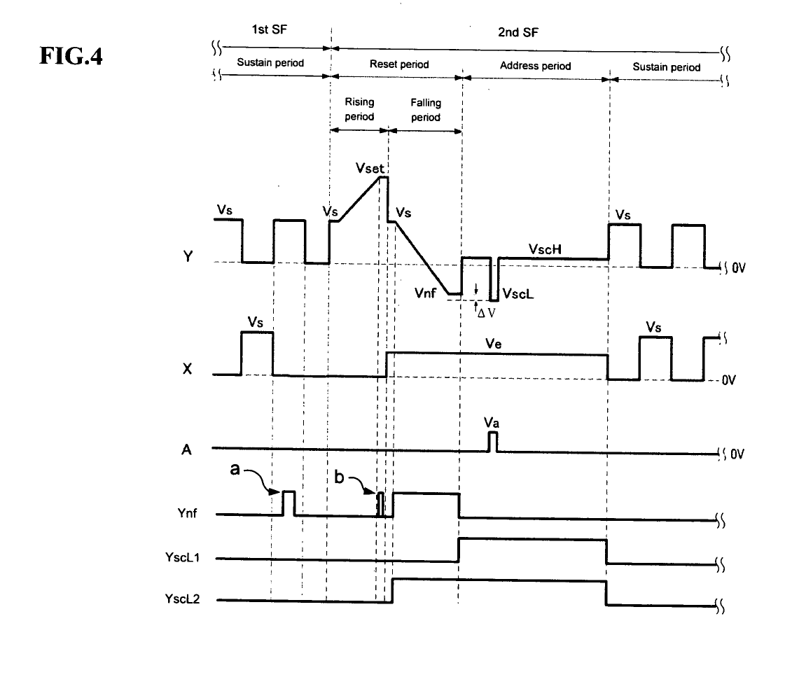

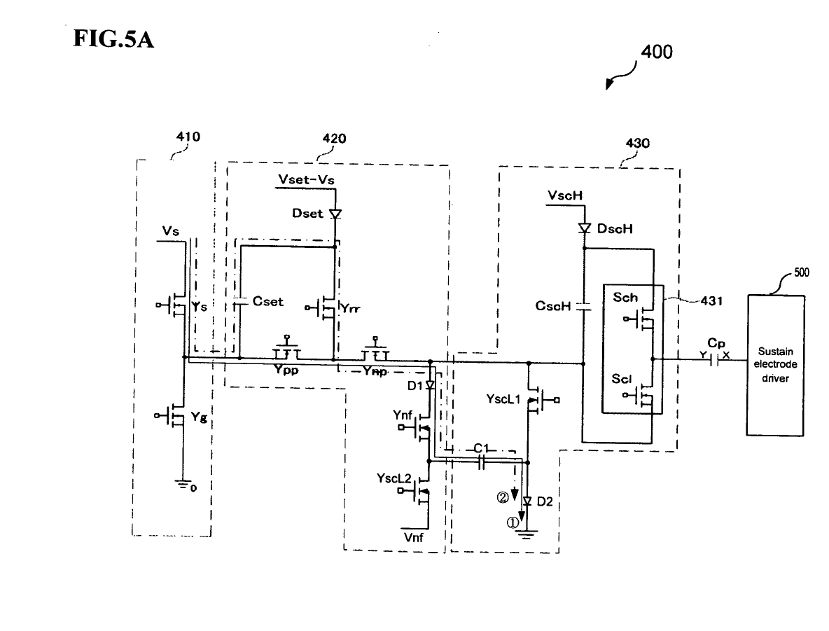

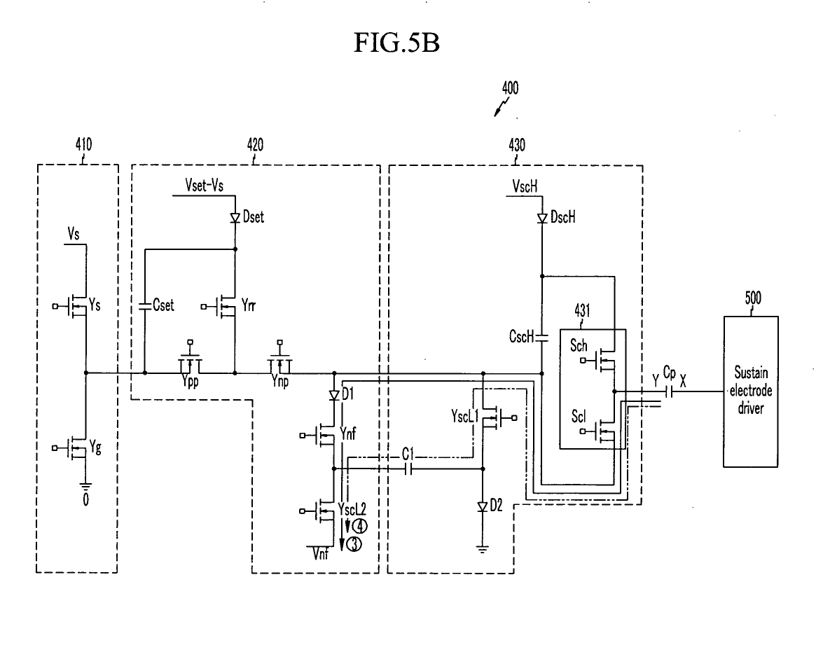

FIG. 4 shows driving waveforms of the plasma display device according to the first exemplary embodiment of the present invention. FIG. 4 includes both the driving waveforms applied to the scan, sustain and address electrodes Y, X, A and the waveforms or pulses applied for turning on and off switches used in FIGS. 5A and 5B.

FIG. 4 shows only a part of driving waveforms related to generation of the voltage Vnf and the voltage VscL among driving waveforms of two consecutive subfields. One subfield of the PDP 100 of FIG. 1 includes a reset period, an address period, and a sustain period depending on variation of voltages applied to the sustain electrodes X, the scan electrodes Y, and the address electrodes A. Variation of the voltages applied to the various electrodes is controlled by the controller 200 of FIG. 1.

The reset period includes a rising period and a falling period. During the rising period, voltage of the scan electrode Y is gradually increased from the voltage Vs to the voltage Vset while the address electrode A and the sustain electrode X are maintained at a reference voltage (i.e., 0V in FIG. 4). The increase of the voltage of the scan electrode Y triggers a weak discharge between the scan electrode Y and the sustain electrode X and between the scan electrode Y and the address electrode A. As a result, negative (−) wall charges are formed on the scan electrode Y and positive (+) wall charges are formed on the sustain electrode X and the address electrode A.

The sum of an external voltage that is applied to the electrodes and a wall voltage difference between the two electrodes when the voltage of the scan electrode Y reaches the voltage Vset corresponds to a discharge firing voltage Vf. The wall voltage is due to wall charges formed on the electrodes. All cells need to be initialized in the reset period, and accordingly, the voltage Vset is set to a voltage that is high enough to generate a discharge in all cells that may be under different wall charge conditions.

Although it is illustrated in FIG. 4 that the voltage of the scan electrode Y is decreased or increased in a ramp pattern, another type of waveform that gradually increases or decreases may be applied.

In the falling period, the voltage of the scan electrode Y is gradually decreased from the voltage Vs to the voltage Vnf while the address electrode A and the sustain electrode X are respectively maintained at the reference voltage and a voltage Ve. The decrease of the voltage of the scan electrode Y triggers a weak discharge between the scan electrode Y and the sustain electrode X and between the scan electrode Y and the address electrode A. As a result, some of the negative wall charges formed on the scan electrode Y and some of the positive wall charges formed on the sustain electrodes and the address electrode A are erased. Accordingly, the negative wall charges formed on the scan electrode Y and the positive wall charges formed on the sustain electrode X and the address electrode A are reduced.

In this case, the positive wall charges formed on the address electrode A are reduced to an amount that is still sufficient for an address operation. In general, the size of the voltage (Vnf−Ve) is set close to a discharge firing voltage Vf between the scan electrode Y and the sustain electrode X. Therefore, a wall voltage difference between the scan electrode Y and the sustain electrode X becomes close to 0V so that misfiring of cells that have not been addressed during the address period can be prevented during a following sustain period.

Each subfield includes one falling period. On the contrary, existence of a rising period for each subfield is determined by a control program of the controller 200 of FIG. 1.

During the address period, while the Ve voltage is applied to the sustain electrode X, a scan pulse having a voltage VscL is sequentially applied to the plurality of scan electrodes Y so as to select the on or light emitting cells. Simultaneously, an address voltage of Va is applied to an address electrode A that passes through the light emitting cells among a plurality of cells formed along the scan electrode Y to which the voltage VscL is applied. The address voltage Va is an address select voltage for selecting the address electrodes of the cells that are selected for emitting light during a subsequent sustain period.

Accordingly, an address discharge is generated between the address electrode A receiving the address voltage Va and the scan electrode Y receiving the voltage VscL and between the scan electrode Y receiving the voltage VscL and a sustain electrode that corresponds to the address electrode A that is receiving the address voltage Va. As a result of the address discharge, positive wall charges are formed on the scan electrode Y and negative wall charges are formed on the address electrode A and the sustain electrode X. In the embodiment shown, the voltage VscL is set to be lower than the voltage Vnf.

A scan electrode Y to which the voltage VscL is not applied receives a voltage VscH (non-scan voltage) that is higher than the voltage VscL. An address electrode of an unselected discharge cell is maintained at the reference voltage.

During the sustain period, a sustain discharge pulse alternately having a high level (voltage Vs in FIG. 4) and a low level (0V in FIG. 4) is applied to the scan electrode Y and the sustain electrode X. The phase of the sustain discharge pulse applied to the scan electrode Y is opposite to the phase of the sustain discharge pulse applied to the sustain electrode X.

Accordingly, in the embodiment shown in FIG. 4, the reference voltage (0V) is applied to the sustain electrode X when the voltage Vs is applied to the scan electrode Y and the reference voltage (0V) is applied to the scan electrode Y when the voltage Vs is applied to the sustain electrode X. As a result, a discharge is generated between the scan electrode Y and the sustain electrode X by the combination of the wall voltage and the voltage Vs. The wall voltage is formed between the scan electrode Y and the sustain electrode X due to the address discharge and the voltage Vs.

The process of applying the sustain discharge pulse to the scan electrode Y and the sustain electrode X are repeated a number of times corresponding to a weight of the corresponding subfield.

The on/off driving operation of the transistors Ynf, YscL1, and YscL2 of FIG. 3 for generating the voltage Vnf and the voltage VscL of the driving waveforms of the scan electrode Y will be described with reference to FIG. 5A and FIG. 5B. The driving waveforms or on/off pulses applied to the transistors Ynf, YscL1, and YscL2 are illustrated in FIG. 4 below the driving waveforms of the scan, sustain and address electrodes Y, X, A. Various pulses shown in FIG. 4 for turning on and off the transistors Ynf, YscL1, and YscL2 apply to various current paths shown in FIGS. 5A and 5B. Therefore, in some embodiments only some of the waveforms shown are applied to a corresponding transistor. For example and as explained below, in the case of the transistor Ynf, pulse “a” establishes one current path, pulse “b” establishes another current path, and the pulse applied to the transistor Ynf during the falling period of the reset period corresponds to yet another current path.

FIG. 5A shows a first current path \textcircled{1} and a second current path \textcircled{2} formed for charging the capacitor C1 of the scan electrode driver 400 according to the first exemplary embodiment. FIG. 5B shows the current paths formed for supplying the voltage Vnf and the voltage VscL to the scan electrode Y by using the scan electrode driver 400 according to the first exemplary embodiment of the present invention.

The first current path and the second current path \textcircled{1}, \textcircled{2} will be described with reference to FIG. 5A.

When the transistors Ys, Ynp, and Ynf are turned on, the first current path \textcircled{1} is formed from the power source Vs that supplies the voltage Vs through the transistor Ys, a body diode of the transistor Ypp, the transistor Ynf, the diode D1, the capacitor C1, and the diode D2, to ground.

The first current path \textcircled{1} is formed by turning on the transistor Ynf when the voltage Vs is applied to the scan electrode Y during a sustain period of the first subfield 1^{st} SF1 of FIG. 4. To form the first current path \textcircled{1}, the transistor Ynf is turned on by applying the pulse “a” in FIG. 4. If the transistor Ynf is turned on while the voltage level applied to the scan electrode Y is changing from 0V to the voltage Vs, a side effect may be generated so that the voltage Vs may be applied to the scan electrode Y at a slow speed.

On the contrary, if the sustain driver 410 includes an ERC, then, when the transistor Ynf is turned off while the voltage level applied to the scan electrode Y is changing from the voltage Vs to 0V, the energy recovery operation of the ERC may be impacted. For this reason, in order to form the first current path \textcircled{1}, the transistor Ynf is maintained in the turn-on state only while the voltage Vs is applied to the scan electrode Y, as shown by “a” FIG. 4. The turn-on state, or on state, refers to the switch being on and turn-on period is a period during which the switch is on. As shown, the waveform “a” does not coincide with the rise of the pulse Vs from 0V to Vs or with the fall of this pulse from Vs to 0V.

The second current path \textcircled{2} is formed from the power source Vs, through the transistor Ys, the capacitor Cset, the transistor Yrr, the transistor Ynp, the diode D1, the transistor Ynf, the capacitor C1, and the diode D1, to ground when the transistors Ys, Yrr, Ynp, and Ynf are turned on.

The second current path \textcircled{2} is formed by turning on the transistor Ynf while the voltage Vset is applied to the scan electrode Y during the reset period of the second subfield 2^{nd} SF2 of FIG. 4. To form the second current path \textcircled{2}, the transistor Ynf is turned on by applying the pulse “b” in FIG. 4. As shown by waveform “b” of FIG. 4, the transistor Ynf is maintained in the turn-on state only while the voltage Vset is applied to the scan electrode Y so as to form the second current path \textcircled{2}.

The first current path \textcircled{1} and the second current path \textcircled{2} are formed to charge the capacitor C1, and the capacitor C1 can be charged by either one of the paths or both. The amount of voltage charged in the capacitor C1 is proportional to the duration of the turn-on state of the transistor Ynf, and therefore the charging voltage can be changed by controlling the on and off periods of the transistor Ynf. The amount of voltage charged in the capacitor C1 may be predetermined.

A third current path \textcircled{3} and a fourth current path \textcircled{4} formed by using the scan electrode driver 400 according to the first exemplary embodiment of the present invention will be described with reference to FIG. 5B. The third current path \textcircled{3} is formed to apply the voltage Vnf and the fourth current path \textcircled{4} is formed to apply the voltage VscL.

When the transistors Scl, Ynf, and YscL2 are turned on, the third current path (D is formed from the panel capacitor Cp through the transistor Scl, the diode D1, the transistor Ynf, and the transistor YscL2 to the power source Vnf that supplies the voltage Vnf.

The voltage applied to the scan electrode Y is decreased from the voltage Vs to the voltage Vnf through the third current path \textcircled{3} during the falling period of the reset period of FIG. 4. The transistors Ynf and YscL2 are turned on after some time passes following the application of the voltage Vs to the scan electrode Y during the falling period of the reset period shown in FIG. 4. The time interval between the start of the application of Vs to the scan electrode Y and the start of the pulse for turning on the transistors Ynf and YscL2 may be predetermined. Turn-on time is the time at which the switch is turned on. FIG. 4 shows the turn-on time of the transistor Ynf to coincide with the turn-on time of the transistor YscL2, but the transistor YscL2 may be set to be turned on earlier than the transistor Ynf. Therefore, the current from the panel capacitor Cp through the transistor Scl, the diode D1, and the transistor Ynf is prevented from flowing to the capacitor C1. In this alternative situation, the transistor Ynf is turned on only when the capacitor C1 is charged through the first or second current paths or only when the voltage Vnf is applied to the scan electrode Y.

When the transistors Scl, YscL1, and YscL2 are turned on, the fourth current path \textcircled{4} is formed from the panel capacitor Cp through the transistor Scl, the transistor YscL1, the capacitor C1, and the transistor YscL2, to the power source Vnf.

The voltage VscL is sequentially applied to the plurality of scan electrodes Y, through the fourth current path \textcircled{4}, to select light emitting cells during the address period of FIG. 4. The voltage VscL is proportional to the amount of voltage charged to the capacitor C1 through the first current path \textcircled{1} or the second current path \textcircled{2}, and is set to be lower than the voltage Vnf. In FIG. 4 the difference between Vnf and VscL is shown as ΔV. Accordingly, the size of ΔV can be changed. Voltage at a node between the transistor YscL1 and the capacitor C1 is lower than the ground voltage when current flows through the fourth current path \textcircled{4}, and the diode D2 is provided to prevent the flow of ground voltage to the capacitor C1.

As shown in FIG. 4, both the transistor YscL2 that has been turned on substantially as the transistor Ynf is turned on and the transistor YscL1 that has been turned on as the address period is started are turned off at the end of the address period. Both the transistor YscL1 and the transistor YscL2 remain on during the address period to apply the voltage VscL to the scan electrode Y when the transistor Scl is turned on. The transistor Scl is turned off when the voltage VscH is applied to the scan electrode Y and no current flows through the fourth current path \textcircled{4}.

As explained above, different pulses of FIG. 4 may correspond to different current paths. In the case of the transistor Ynf, pulse “a” establishes the first current path \textcircled{1}, pulse “b” establishes the second current path \textcircled{2}, and the pulse applied to the transistor Ynf during the falling period of the reset period corresponds to the third current path \textcircled{3}.

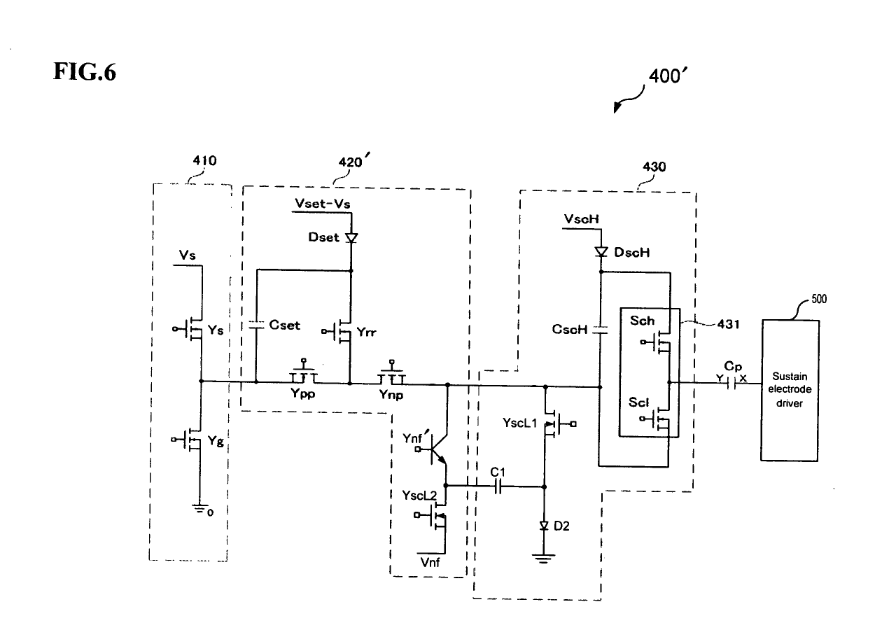

FIG. 6 shows driving circuit of a scan electrode driver according to a second exemplary embodiment of the present invention.

The scan electrode driver 400′ (in FIG. 6) according to the second exemplary embodiment of the present invention is similar to the scan electrode driver 400 (in FIG. 3) according to the first exemplary of the present invention, and therefore only differences between the two drivers will be described.

The scan electrode driver 400′ of FIG. 6 includes a transistor Ynf′ that can be used to replace the diode D1 and the transistor Ynf included in the reset driver 420 of the scan electrode driver 400 in the first exemplary embodiment. The transistor Ynf′ may be implemented by an insulated gate bipolar transistor (IGBT) that, unlike the transistor Ynf, does not include a body diode and accordingly, the scan electrode driver 400′ does not need to have the diode D1 to interrupt the effect of the body diode.

The scan electrode driver 400′ in the second exemplary embodiment is driven in the same manner as the scan electrode driver 400 in the first exemplary embodiment, and therefore a further description will be omitted.

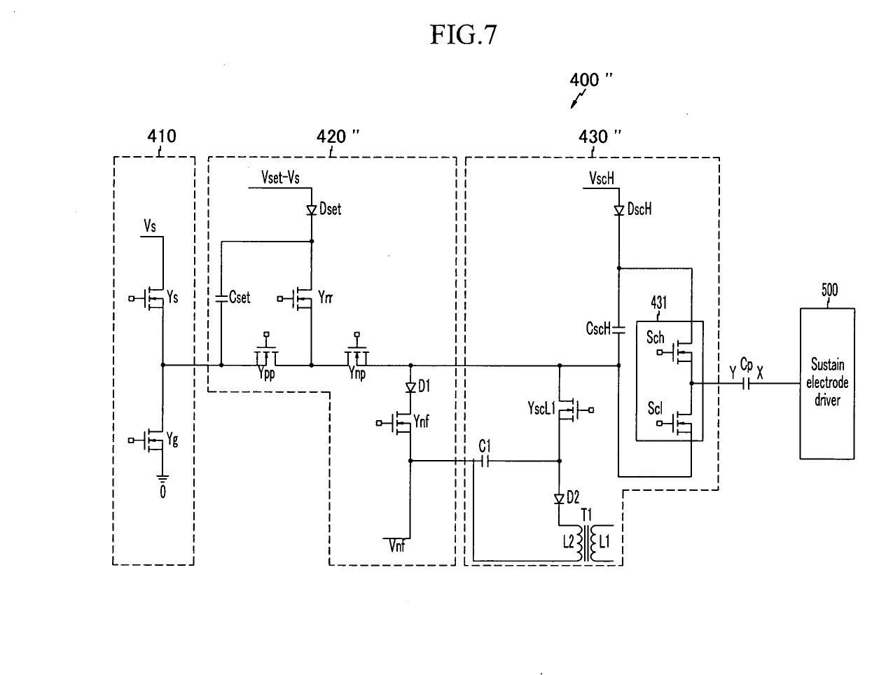

The scan electrode drivers 400 and 400′ according to the first and second exemplary embodiments of the present invention charge the capacitor C1 by using the voltages Vs and Vset applied to the scan electrode Y. Therefore, precise matching of the timings is required to match the driving timing of the sustain driver 410, the reset driver 420, 420′, and the scan driver 430. Unlike the scan electrode drivers 400, 400′ according to the first and second embodiments of the present invention, a scan electrode driver 400″ according to a third exemplary embodiment of the present invention is shown in FIG. 7 that does not require forming a current path for charging the capacitor C1 in order to avoid potential mismatch of timings. The scan electrode driver 400″ according to the third exemplary embodiment of the present invention will be described with reference to FIG. 7.

FIG. 7 shows a driving circuit of the scan electrode driver according to the third exemplary embodiment of the present invention.

The scan electrode driver 400″ is similar to the scan electrode driver 400 in the first exemplary embodiment, and therefore redundant descriptions will be omitted and only differences will be described.

As shown in FIG. 7, a reset driver 420″ of the scan electrode driver 400″ does not include the transistor YscL2 included in the reset driver 420 of the scan electrode driver 400. Further, a cathode of a diode D2 of a scan driver 430″ is coupled to a first end of a secondary coil L2 of a transformer T1 rather than being coupled to ground. A second end of the secondary coil L2 of the transformer T1 is coupled to a second end of a capacitor C1, and a voltage induced from a primary coil L1 and generated in the second coil L2 charges the capacitor C1. In this case, the primary coil T1 of the transformer T1 receives a voltage from the power supply 200 of FIG. 2, and the voltage of the primary coil is varied according to a control signal of the controller 200, causing the voltage of the secondary coil that is charging the capacitor C1 to be modified. The voltage VscL is set lower than the voltage Vnf by an amount ΔV that is proportional to the amount of voltage charged in the capacitor C1. That is, the size of ΔV can be modified by changing the voltage charged in the capacitor C1. Therefore, the difference between Vnf, that impacts the wall charge state of the cells prior to the address period, and VscL, that impacts the address discharge voltage, can be controlled. The size of ΔV may be predetermined.

The scan electrode driver 400″ in the third exemplary embodiment is driven in the same manner as the scan electrode drivers 400 and 400′ in the first and second exemplary embodiments, except that the scan electrode driver 400″ does not need to provide current through the first current path \textcircled{1} and the second current path \textcircled{2} to charge the capacitor C1.

Alternatively, the transistor Ynf and the diode D1 of the reset driver 420″ of the scan electrode driver 400″ can be replaced with one insulated gate bipolar transistor (IGBT) as in the second exemplary embodiment.

The scan electrode drivers 400, 400′, and 400″ according to the first, second, and third exemplary embodiments of the present invention can reduce implementation costs and driving power consumption compared to the conventional scan electrode driver using a Zener diode having a high withstand voltage. Further, discharge margin can be handled by varying the size of ΔV to correspond to the design of the plasma display device and discharge space variation.

The scan electrode drivers 400, 400′, and 400″ according to the first, second, and third exemplary embodiments of the present invention shown respectively in FIG. 3, FIG. 6, and FIG. 7 can also be used as the sustain electrode driver 100 of FIG. 1 for driving the sustain electrode X.

As described above, the implementation costs and driving power consumption of the plasma display device can be reduced by eliminating the use of the Zener diode having a high withstand voltage.

In addition, since the voltage difference ΔV between the voltages VscL and Vnf can be controlled to correspond with the design of the plasma display device, a sufficient discharge margin in the address period can be obtained or at least the discharge margin can be improved. Accordingly, the address discharge voltage can be reduced, thereby driving the plasma display device with low power consumption. The address discharge voltage may be reduced to below a predetermined level in some embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a plasma display panel having first electrodes, second electrodes, and third electrodes crossing a direction of the first electrodes and the second electrodes;
a power supply receiving an input voltage and including a first power source for generating a first voltage;
a first driving circuit for driving the first electrodes, the first driving circuit coupled to the power supply; and
a controller for generating a control signal for controlling the first driving circuit, the controller receiving power from the power supply,
wherein the first driving circuit includes:
a first switch having a first end coupled to the first power source for supplying the first voltage;
a second switch having a first end coupled to a second end of the first switch and a second end coupled to a first electrode from among the first electrodes;
a third switch having a first end coupled to the first electrode and a second end coupled to a second power source for supplying a second voltage; and
a first capacitor having a first end coupled to a node between the first switch and the second switch and a second end coupled to the second end of the third switch.

2. The plasma display device of claim 1, wherein the first driving circuit further comprises a first diode having an anode coupled to the first electrode and a cathode coupled to the second end of the second switch.

3. The plasma display device of claim 1, wherein the first driving circuit further comprises a second diode having an anode coupled to a node between the third switch and the first capacitor and a cathode coupled to the second power source.

4. The plasma display device of claim 1,
wherein the plasma display device is driven during frames, each frame divided into subfields and each subfield including a reset period, an address period and a sustain period, and
wherein the first switch is turned on during a portion of the reset period and is turned off at an end of the address period.

5. The plasma display device of claim 1,
wherein the first capacitor is charged to a third voltage through the second switch, and
wherein the third voltage being charged in the first capacitor is proportional to a turn-on period of the second switch.

6. The plasma display device of claim 5,
wherein the plasma display device is driven during frames, each frame being divided into subfields and each subfield including a reset period, an address period and a sustain period,
wherein during the sustain period a fourth voltage and a fifth voltage are alternately applied to the first electrodes, the fourth voltage being lower than the fifth voltage, and
wherein during a period included within a period of applying the fifth voltage to the first electrodes during the sustain period, the second switch is maintained in a turn-on state to charge the first capacitor to the third voltage.

7. The plasma display device of claim 5,
wherein the plasma display device is driven during frames, each frame being divided into subfields and each subfield including a reset period, an address period and a sustain period,
wherein the reset period of one or more of the subfields includes a rising period and a falling period, and
wherein during a set portion of the rising period of the reset period, a voltage of the first electrode is maintained at a sixth voltage being a highest voltage applied to the first electrode during the subfield, and
wherein during a second period within the set portion of the rising period, the second switch is maintained in the turn-on state to charge the first capacitor with the third voltage.

8. The plasma display device of claim 6, wherein the first period is varied in accordance with the control signal.

9. The plasma display device of claim 7, wherein the second period is varied in accordance with the control signal.

10. The plasma display device of claim 4, wherein the second switch is turned on when the first switch is turned on and is turned off when the reset period ends to apply the first voltage to the first electrode.

11. The plasma display device of claim 4, wherein the third switch is maintained in the turn-on state during the address period to apply a seventh voltage to the first electrode, the seventh voltage being lower than the first voltage by the third voltage.

12. The plasma display of claim 11, wherein the seventh voltage corresponds to a scan select voltage that is sequentially applied to the first electrodes during the address period.

13. The plasma display of claim 1, wherein the first voltage is lower than the second voltage.

14. The plasma display device of claim 1, wherein the second voltage corresponds to a ground voltage.

15. A plasma display device comprising:
a plasma display panel having a plurality of first electrodes, a plurality of second electrodes, and a plurality of third electrodes crossing a direction of the first and second electrodes;
a power supply including a first power source for generating a first voltage by converting an input voltage;
a first driving circuit for driving the plurality of first electrodes; and
a controller for generating a control signal for controlling a driving operation of the first driving circuit,
wherein the first driving circuit includes:
a first switch having a first end coupled to the first power source for supplying the first voltage and a second end coupled to a first electrode from among the plurality of first electrodes;
a second switch having a first end coupled to the first electrode;
a first capacitor having a first end coupled to the first end of the first switch and a second end coupled to the second switch;
a first diode having an anode coupled to the second end of the first capacitor; and
a first transformer having a primary coil and a secondary coil, a second voltage being applied to the primary coil and the secondary coil having a first end coupled to the first end of the first capacitor and a second end coupled to the second end of the first capacitor,
wherein the first transformer charges the first capacitor with a third voltage being generated in proportion to the second voltage.

16. The plasma display device of claim 15, wherein the first driving circuit further comprises a second diode having an anode coupled to the first electrode and a cathode coupled to the second end of the first switch.

17. The plasma display device of claim 15,
wherein the plasma display device is driven during frames divided into subfields, each subfield including a reset period, an address period and a sustain period, the sustain period following the address period and the address period following the reset period, and
wherein the first switch is turned on during a portion of the reset period to apply the first voltage to the first electrode and is turned off when the address period begins.

18. The plasma display device of claim 17, wherein the second voltage varies according to the control signal.

19. The plasma display device of claim 18, wherein the second switch is maintained in a turn-on state during the address period to apply a fourth voltage to the first electrode, the fourth voltage being lower than the first voltage by a magnitude of the third voltage.

20. The plasma display device of claim 19, wherein the fourth voltage corresponds to a scan select voltage being sequentially applied to the plurality of first electrodes during the address period.

21. A driving method of a plasma display device having a controller, a plurality of first electrodes, a plurality of second electrodes, and a plurality of third electrodes crossing a direction of the first electrodes and the second electrodes,
the plasma display device further including:
a first switch having a first end coupled to a first power source, the first power source supplying a first voltage;
a second switch having a first end coupled to a second end of the first switch and a second end coupled to a first electrode from among the plurality of first electrodes;
a third switch having a first end coupled to the first electrode and a second end coupled to a second power, the second power source supplying a second voltage; and
a first capacitor having a first end coupled to a node between the first switch and the second switch and a second end coupled to the second end of the third switch,
the driving method comprising:
charging the first capacitor with a third voltage by turning on the second switch and turning off the first switch and the third switch;
applying the first voltage to the first electrode by turning on the first switch and the second switch and turning off the third switch; and
applying a fourth voltage to the first electrode by turning on the first switch and the third switch and turning off the second switch, the fourth voltage being lower than the first voltage by a magnitude of the third voltage.

22. The driving method of claim 21, wherein the first voltage is the lowest voltage among voltages applied to the first electrode during a reset period, the reset period being a period for resetting discharge cells of the plasma display device, the discharge cells being formed where the plurality of first electrodes and the plurality of second electrodes cross over the plurality of third electrodes.

23. The driving method of claim 21, wherein the fourth voltage corresponds to a scan select voltage that is sequentially applied to the plurality of first electrodes.
